(19) United States
(12) Patent Application Publication
(10) Pub. No.: US 2012/0289110 A1
(43) Pub. Date: Nov. 15, 2012

(54) SILICONE COATING COMPOSITION FOR AIR BAGS

(76) Inventors: William Blackwood, Midland, MI (US); David Danielson, Midland, MI (US); Robert W. Pippenger, Grand Junction, CO (US); Randall Paul Sweet, Midland, MI (US)

(21) Appl. No.: 13/519,880

(22) PCT Filed: Dec. 27, 2010
(86) PCT No.: PCT/US10/62149

§ 371 Date: Jun. 28, 2012

Related U.S. Application Data
(60) Provisional application No. 61/290,928, filed on Dec. 30, 2009.

(51) Int. Cl. C09D 183/07; C08K 3/36; B05D 1/02; B05D 3/12; B05D 1/28; B05D 1/18; B32B 25/10; B05D 1/26

(52) U.S. Cl. 442/59; 524/500; 427/288; 427/358; 427/355; 427/428.01; 427/430.1; 427/427.4

(57) ABSTRACT

Silicone rubber compositions for coating air bags, used for safety purposes to protect occupants of vehicles such as automobiles are described together with air bag fabrics coated with the composition and to air bags made from the coated fabric. The compositions are silicone rubber coating compositions which cure by hydrosilylation comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, wherein the silica filler is pre-treated with 2% to 60% by weight based on the weight of the silica filler of an oligomeric organopolysiloxane containing Si-bonded methyl and vinyl groups and silanol end groups.

This invention relates to silicone rubber compositions for coating air bags, which are used for safety purposes to protect occupants of vehicles such as automobiles. The invention also relates to air bag fabrics coated with the composition and to air bags made from the fabric. In particular the invention relates to silicone rubber coating compositions which cure by hydrosilylation, that is by the reaction of alkenyl groups of one polyorganosiloxane and Si-bonded hydrogen groups of another polyorganosiloxane.

Air bags are generally formed from a woven or knitted fabric made of synthetic fibre, for example of polyamide such as nylon-6,6 or polyester, covered on at least one of its sides with a layer of an elastomer. Air bags may be made of flat fabric pieces which are coated and then sewn together to provide sufficient mechanical strength, or may be woven in one piece with integrally woven seams. Sewn air bags are generally assembled with the coated fabric surface at the inside of the air bag. One piece woven air bags are coated on the outside of the air bag. Use of silicone rubber as the elastomer coating on the air bag base fabric provides excellent high-temperature properties, in addition to which the ability to coat the base fabric with a thin film of silicone rubber, for example 15 to 50 g/m², makes it possible to achieve a lightweight construction. It is however difficult to ensure sufficient air tightness (i.e. low enough gas permeability of the coated fabric) at low coating weights.

Silicone rubber air bag coatings are disclosed in many patents. For example U.S. Pat. No. 6,709,752 discloses a composition for coating textile fabrics which is hydrosilylation reaction-curable and comprises of polyorganosiloxanes of three types, two of which are alkenyl-terminated polyorganosiloxanes having two different specific viscosities and the third having alkenyl groups on molecular terminals and in side chains, an organosilicon crosslinker having at least 3 silicon-bonded hydrogen atoms, a catalyst and a reinforcing filler.

U.S. Pat. No. 6,425,600 describes a silicone rubber composition for coating air bags comprising an organopolysiloxane having at least two silicon-bonded alkenyl groups per molecule, finely divided silica, an adhesive component, a silicone-soluble resin bearing at least one alkenyl group per molecule, an organohydrogenpolysiloxane, and a platinum group catalyst.

WO-A-08/020605 describes a silicone-rubber composition for coating textile fabrics comprising the following components: an alkenyl group-containing organopolysiloxane (A) that comprises a mixture of an organopolysiloxane (A-1) that contains no more than 2% alkenyl groups and an organopolysiloxane (A-2) that contains 5% or more alkenyl groups, A-2 being present at no more than 1% by weight based on A-1; an organohydrogenpolysiloxane (B) that comprises a mixture of an organohydrogenpolysiloxane (B-1) that has on average three silicon-bonded hydrogen atoms per molecule and an organohydrogenpolysiloxane (B-2) that has on average two silicon-bonded hydrogen atoms per molecule; a hydrosilylation catalyst (C); and a reinforcement fine silica powder (D).

U.S. Pat. No. 6,511,754 describes a coating composition comprising at least one polyorganosiloxane having, per molecule, at least two C2-C6 alkenyl groups linked to the silicon, at least one polyorganosiloxane having, per molecule, at least two hydrogen atoms linked to the silicon, a catalyst based on a metal belonging to the platinum group, a reinforcing siliceous filler treated in situ by a compatibilizer in the presence of the alkenyl-functional polyorganosiloxane, a polyorganosiloxane termed an extender and having terminal siloxyl units with hydrogeno functional groups, and a ternary adhesion promoter comprising at least one possibly alkoxylated organosilane containing at least one C3-C6 alkenyl group, at least one organosilicon compound which includes at least one epoxy radical, and a metal chelate and/or metal alkoxide.

WO-A-08/020635 describes a silicone-rubber composition for coating fabric comprising an alkenyl-containing organopolysiloxane, an organohydrogenpolysiloxane, a hydrosilylation catalyst, a finely powdered reinforcing silica, a methacryl- or acryl-containing alkoxysilane, and a zirconium chelate compound.

For some airbag applications, pressurised gases are to be retained in a fabric envelope for a relatively long period. This requirement exists for example in side curtain airbags for the automotive industry. These side curtain airbags are intended to inflate at the time of impact, as do conventional airbags. The side curtains unfold to form a cushioned curtain between passengers and some of the side of the car body, e.g., the windows. As the intention is not merely to cushion the blow on impact itself, as is the case for conventional driver and passenger airbags, but to protect passengers e.g. when a car is rolling, it is important that the side curtain air bag is sufficiently pressurised during such rolling process. Where conventional driver and passenger airbags only need to retain pressure for a fraction of a second, it is desirable that side curtain airbags maintain a suitable pressure for a few seconds. Similar applications exist where a pressurised fabric structure is desired to maintain a certain fluid pressure for a relatively extended period of time, e.g. in emergency chutes for aeroplanes, or inflatable rafts. There is thus a demand for coated fabrics having the benefits of flexibility and high temperature resistance at low coating weight given by silicone rubber coatings, but with improved air tightness.

A coating composition for an air bag according to one aspect of the present invention comprises an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, wherein the silica filler is pre-treated with 2% to 60% by weight based on the silica filler of an oligomeric organopolysiloxane containing Si-bonded methyl and vinyl groups and silanol end groups.

According to another aspect of the invention a coating composition for an air bag comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, characterized in that the composition contains 2% to 60% by weight based on the silica filler of an oligomeric organopolysiloxane containing Si-bonded methyl and vinyl groups and silanol end groups.

The invention includes a process for coating a fabric with a coating composition comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, characterized in that the composition contains 2% to 60% by weight based on the silica filler of an oligomeric organopolysiloxane containing Si-bonded methyl and vinyl groups and silanol end groups. For the sake of clarification, it is to be understood that where compositions are described in % values the total amount of the composition always adds up to 100%.

The invention also includes an air bag or air bag fabric coated with a coating composition comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, characterized in that the composition contains 2% to 60% by weight based on the silica filler of an oligomeric organopolysiloxane containing Si-bonded methyl and vinyl groups and silanol end groups.

The invention includes a process for preparing a coating composition curable to a silicone rubber, said coating composition comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a silica reinforcing filler, wherein the silica filler is treated with 2% to 60% by weight based on the silica filler of an oligomeric organopolysiloxane containing Si-bonded methyl and vinyl groups and silanol end groups and the filler thus treated is mixed with an organopolysiloxane (A) having aliphatically unsaturated hydrocarbon or hydrocarbonoxy substituents, the organosilicon crosslinker having at least 3 silicon-bonded hydrogen atoms and the catalyst.

We have found that pre-treating the silica filler with the oligomeric organopolysiloxane containing Si-bonded methyl and vinyl groups and silanol end groups reduces the permeability of fabric coated with silicone rubber coating composition containing the silica filler. This pre-treatment of the silica filler also improves the adhesion of the coating composition to fabric, particularly to the woven nylon or polyester fabrics used for air bags. Air bags made from fabric coated with the coating composition of the invention have significantly improved air tightness.

The reinforcing silica filler can for example be fumed (pyrogenic) silica, such as that sold by Cabot under the trade mark Cab-O-Sil MS-75D, precipitated silica or gel-formation silica. The specific surface area of this reinforcing silica filler is preferably at least 50 m²/g.

The silica filler generally comprises at least 1% by weight of the whole coating composition and can for example be present at up to 40% by weight of the coating composition. Preferably the silica filler is present at 2 to 30% by weight of the coating composition.

The oligomeric organopolysiloxane used to treat the filler contains Si-bonded methyl and vinyl groups and silanol end groups. The oligomeric organopolysiloxane can for example be a methylvinylpolysiloxane in which both molecular terminals are dimethylhydroxysiloxy units, or a copolymer of a methylvinyl siloxane and dimethylsiloxane units in which both molecular terminals are dimethylhydroxysiloxy units. The oligomeric organopolysiloxane can be a mixture of organopolysiloxane molecules, some of which have silanol end groups at both molecular terminals and some of which have only one silanol group such as a dimethylhydroxysiloxy terminal unit with the other terminal unit being for example a dimethylmethoxysiloxy unit, a trimethylsiloxy unit or a dimethylvinylsiloxy unit. Preferably more than 50% by weight of the oligomeric organopolysiloxane, more preferably 60-100%, comprises molecules having silanol end groups at both molecular terminals.

The oligomeric organopolysiloxane preferably contains at least 3%, more preferably at least 5%, by weight vinyl groups, and can contain up to 35 or 40% by weight vinyl groups. Most preferably the oligomeric organopolysiloxane contains 5 to 30% by weight vinyl groups. The oligomeric organopolysiloxane preferably has a weight average molecular weight of 1000 to 10000 as determined via gel permeation chromatography methods. The oligomeric organopolysiloxane preferably has a viscosity not exceeding 50 mPa·s at 25° C., more preferably a viscosity of 0.1 to 40 mPa·s at 25° C. and most preferably 1 to 40 mPa·s. at 25° C. Viscosity measurements are given based on measurements using a Brookfield Viscometer with spindle 7 at 10 rpm unless otherwise indicated.

The oligomeric organopolysiloxane containing Si-bonded methyl and vinyl groups and silanol end groups can be regarded as part of the polyorganosiloxane (A) having aliphatically unsaturated hydrocarbon or hydrocarbonoxy substituents. The total polyorganosiloxane (A) in the coating composition however generally contains less than 5% and preferably less than 3% by weight alkenyl groups. The polyorganosiloxane (A) preferably contains 0.02% to 2% by weight alkenyl groups. The oligomeric organopolysiloxane can for example comprise 0.1% to 10% by weight of the total polyorganosiloxane (A) in the coating composition.

The alkenyl groups of the organopolysiloxane (A) can be exemplified by vinyl, allyl, butenyl, pentenyl, hexenyl, and heptenyl groups, of which vinyl groups are preferred. Silicon-bonded organic groups other than alkenyl groups contained in organopolysiloxane (A) may be exemplified by methyl, ethyl, propyl, butyl, pentyl, hexyl, or similar alkyl groups; phenyl, tolyl, xylyl, or similar aryl groups; or 3-chloropropyl, 3,3,3-trifluoropropyl, or similar halogen-substituted groups. Preferably, the groups other than alkenyl groups are methyl groups and optionally phenyl groups.

It is preferred that the major part of organopolysiloxane (A) has a predominantly linear molecular structure. The organopolysiloxane (A) can for example comprise an amvinyldimethylsiloxy polydimethylsiloxane, an α,ω-vinyldimethylsiloxy copolymer of methylvinylsiloxane and dimethylsiloxane units, and/or an α,ω-trimethylsiloxy copolymer of methylvinylsiloxane and dimethylsiloxane units. The polyorganosiloxane (A) preferably has a viscosity of at least 100 mPa·s at 25° C., preferably at least 300 mPa·s, and may have a viscosity of up to 90000 mPa·s, preferably up to 70000 mPa·s. Most preferably the polyorganosiloxane (A) comprises at least one α,ω-vinyldimethylsiloxy polydimethylsiloxane having a viscosity of from 100 to 90000 mPa·s at 25° C. The polyorganosiloxane (A) can for example comprise a first α,ω-vinyldimethylsiloxy polydimethylsiloxane having a viscosity at 25° C. of from 50 to 650 mPa·s and a second α,ω-vinyldimethylsiloxy polydimethylsiloxane having a viscosity at 25° C. of 10,000 to 90000 mPa·s as described in U.S. Pat. No. 6,709,752. All viscosity measurements herein are measured at 25° C. unless otherwise indicated.

The organopolysiloxane (A) can optionally additionally comprise a branched organopolysiloxane containing alkenyl units (A1). Such a branched organopolysiloxane can for example comprise ViSiO_{3/2} (where Vi represents vinyl), CH₃SiO_{3/2} and/or SiO_{4/2} branching units with (CH₃₎₂Vi SiO_{1/2} and/or (CH₃₎₃SiO_{1/2} and optionally CH₃Vi SiO_{2/2} and/or (CH₃₎₂SiO_{2/2} units, provided that at least one vinyl group is present. A branched organopolysiloxane (A1) can for example consist of (i) one or more Q units of the formula(SiO_{4/2}) and (ii) from 15 to 995 D units of the formula R^{b}₂SiO_{2/2}, which units (i) and (ii) may be inter-linked in any appropriate combination, and M units of the formula R^{a}R^{b}₂SiO_{1/2}, wherein each R^{a} substituent is selected from the group consisting of an alkyl group having from 1 to 6 carbon atoms, an alkenyl group having from 1 to 6 carbon atoms and an alkynyl group having from 1 to 6 carbon atoms, at least three R^{a} substituents in the branched siloxane being alkenyl or alkynyl units, and each R^{b} substituent is selected from the group consisting of an alkyl group having from 1 to 6 carbon atoms, an alkenyl group having 2 to 6 carbon atoms, an aryl group, an alkoxy group, an acrylate group and a methacrylate group, as described in U.S. Pat. No. 6,806,339. We have found that the presence of such a branched organopolysiloxane (Al) as part of the alkenyl functional organopolysiloxane (A) can further reduce the gas permeability of an air bag coated with the composition of the invention and the rate of pressure loss from the air bag when inflated.

Organosilicon cross-linkers for use in the elastomer-forming coating composition according to the invention are preferably selected from silanes, low molecular weight organosilicon resins and short chain organosiloxane polymers. The cross-linker compound has at least 3 silicon-bonded hydrogens per molecule which are capable of reacting with the alkenyl or other aliphatically unsaturated groups of the groups of the polyorganosiloxane (A).

Suitable short chain organosiloxane polymers may be linear or cyclic. Preferred organosilicon cross-linkers have the general formula

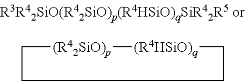

wherein R⁴ denotes an alkyl or aryl group having up to 10 carbon atoms, R³ is a group R⁴ or a hydrogen atom, p has a value of from 0 to 20, g has a value of from 1 to 70, and there are at least 3 silicon-bonded hydrogen atoms present per molecule. It is preferred that R⁴ denotes a lower alkyl group having no more than 3 carbon atoms, most preferably a methyl group. R³ preferably denotes an R⁴ group. Preferably p=0 and q has a value of from 2 to 70, more preferably 2 to 30, or where cyclic organosilicon materials are used, from 3 to 8. It is most preferred that the organosilicon crosslinker is a siloxane polymer having a viscosity of from 1 to 150 mPa·s at 25° C., more preferably 2 to 100 mPa·s, most preferably 5 to 60 mPa·s. The cross-linking organosilicon compound may comprise a mixture of several materials as described. Examples of suitable organosilicon cross-linkers thus include trimethylsiloxane end-blocked polymethylhydrosiloxanes, dimethylhydrosiloxane end-blocked methylhydro siloxane, dimethylsiloxane methylhydrosiloxane copolymers and tetramethylcyclotetrasiloxane.

The molar ratio of Si—H groups in the organosilicon crosslinker to aliphatically unsaturated groups in the organopolysiloxane (A) is preferably at least 1:1 and can be up to 8:1 or 10:1. Most preferably the molar ratio of Si—H groups to aliphatically unsaturated groups is in the range from 1.5:1 to 5:1.

The catalyst able to promote the reaction of the aliphatically unsaturated hydrocarbon or hydrocarbonoxy substituents of organopolysiloxane (A) with the Si—H groups of the organosilicon crosslinker is preferably a platinum group metal (Group VIII of the Periodic Table) or a compound thereof. Platinum and/or platinum compounds are preferred, for example finely powdered platinum; a chloroplatinic acid or an alcohol solution of a chloroplatinic acid; an olefin complex of a chloroplatinic acid; a complex of a chloroplatinic acid and an alkenylsiloxane; a platinum-diketone complex; metallic platinum on silica, alumina, carbon or a similar carrier; or a thermoplastic resin powder that contains a platinum compound. Catalysts based on other platinum group metals can be exemplified by rhodium, ruthenium, iridium, or palladium compounds. For example, these catalysts can be represented by the following formulas:
RhCl(PPh₃)₃, RhCl(CO)(PPh₃)₂, Ru₃(CO)₁₂, IrCl(CO)(PPh₃)₂, and Pd(PPh₃)₄ (where Ph stands for a phenyl group).

The catalyst is preferably used in an amount of 0.5 to 100 parts per million by weight platinum group metal based on the polyorganosiloxane (A), more preferably 1 to 50 parts per million.

The coating composition may contain an additional catalyst, for example a titanium compound such as tetra(isopropoxy)titanium (TiPT).

When preparing the coating composition of the invention, the silica filler is pre-treated with the oligomeric organopolysiloxane containing Si-bonded methyl and vinyl groups and silanol end groups before the silica filler is mixed with the major part of the coating composition. We have found that such pre-treatment reduces the permeability of fabric coated with the silicone rubber coating composition compared to a fabric coated with a similar silicone rubber coating composition containing the oligomeric organopolysiloxane, but in which the silica filler has not been pre-treated with oligomeric organopolysiloxane.

In one process according to the invention, silica filler is mixed with the oligomeric organopolysiloxane substantially dry, that is the silica filler is mixed with the oligomeric organopolysiloxane containing Si-bonded methyl and vinyl groups and silanol end groups in the absence of any other organopolysiloxane. A small amount (generally no more than 25% by weight of the whole mixture) of water, organic solvent and/or a coupling agent adapted to improve the adhesion of the oligomeric organopolysiloxane to the silica filler can be present during the mixing step. The coupling agent can for example be a silazane such as hexamethyldisilazane or tetramethyldisilazane. The treated filler can then be mixed with the other ingredients of the coating composition.

In an alternative process according to the invention, the silica filler is mixed with the oligomeric organopolysiloxane and part of the aliphatically unsaturated hydrocarbon or hydrocarbonoxy substituted organopolysiloxane (A) to form a masterbatch which can then be mixed with the other ingredients of the coating composition, including further aliphatically unsaturated hydrocarbon or hydrocarbonoxy substituted organopolysiloxane (A). The polyorganosiloxane (A) which is mixed with the silica filler and the oligomeric organopolysiloxane is generally an alkenyl functional polyorganosiloxane containing 0.02% to 2% by weight alkenyl groups as described above. It can for example be an α,ω-vinyldimethylsiloxy polydimethylsiloxane having a viscosity of from 100 to 90000 mPa·s at 25° C. The masterbatch thus prepared can for example contain 10 to 80% by weight of the silica filler. The masterbatch may for example contain 5 to 50% by weight of the total polyorganosiloxane (A) used in the elastomer-forming coating composition. Even if the silica filler has been pre-treated with the oligomeric organopolysiloxane containing Si-bonded methyl and vinyl groups and silanol end groups in the absence of any other organopolysiloxane, it may be convenient to then mix the treated filler with part of the aliphatically unsaturated hydrocarbon or hydrocarbonoxy substituted organopolysiloxane (A) to form a masterbatch.

Mixing can be carried out in any convenient form of mixer, for example a sigma-blade or Z-blade mixer, a drum mixer or a ploughshare mixer. When forming a masterbatch, mixing can alternatively be carried out continuously on a roll mill or in a twin screw extruder.

Whether the silica filler is pre-treated with the oligomeric organopolysiloxane containing Si-bonded methyl and vinyl groups and silanol end groups substantially dry or in the presence of some polyorganosiloxane (A) in addition to the oligomeric organopolysiloxane to form a masterbatch, the oligomeric organopolysiloxane is present in an amount of at least 0.8% by weight based on the silica filler, preferably at least 1.5% or 2% by weight. The oligomeric organopolysiloxane can be present at up to 40% or even 50 or 60% by weight based on the silica filler.

The elastomer-forming coating composition may be prepared by merely mixing the ingredients in the desired ratios, with the treated silica filler or the silica filler masterbatch being one of the ingredients that is mixed. However, for reasons of storage stability and bath life before or during application of the composition to the textile fabric, it is usually preferred to store the composition in two parts, by separating the catalyst from the organosilicon cross-linker. The other components of the composition, including the treated silica filler or the silica filler masterbatch, can be in either part of the composition but are preferably distributed over both parts in proportions which will allow easy mixing of the two parts immediately prior to application. Such easy mixing ratios may be e.g. 1/10 or 1/1 ratios.

Other additional components may be included in the coating compositions of the invention, including for example adhesion promoters, other fillers, dyes, pigments, viscosity modifiers, bath-life extenders, inhibitors and/or flexibilisers.

Use of an adhesion promoter may be desired to impart to the composition better adhesion to fabrics such as woven nylon or polyester fabric commonly used as airbag base fabric and to enhance continued adhesion of the coating to the fabric even after long-term exposure of the fabric to conditions of high temperature and high humidity. Suitable adhesion promoters include zirconium chelate compounds and epoxy-functional or amino-functional organosilicon compounds. Suitable zirconium chelate compounds known in the art include the following examples: zirconium (IV) tetraacetyl acetonate, zirconium (IV) hexafluoracetyl acetonate, zirconium (IV) trifluoroacetyl acetonate, tetrakis(ethyltrifluoroacetyl acetonate)zirconium, tetrakis(2,2,6,6-tetramethyl-heptanethionate)zirconium, zirconium (IV) dibutoxy bis(ethylacetonate), diisopropoxy bis(2,2,6,6-tetramethyl-heptanethionate)zirconium, or similar zirconium complexes having β-diketones (including alkyl-substituted and fluoro-substituted forms thereof) which are used as ligands. Most preferable of these compounds are zirconium complexes of acetoacetate (including alkyl-substituted and fluoro-substituted forms). Such a zirconium chelate compound can be used in conjunction with an epoxy-containing alkoxysilane, for example 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane.

Other fillers, if used, can include ground quartz, ground cured silicone rubber particles and calcium carbonate. Such other fillers are preferably present at a lower level than the reinforcing silica filler. Preferably these other fillers have been treated to make their surface hydrophobic. If other fillers are used, they can advantageously be treated with the oligomerie organopolysiloxane together with the silica filler.

Examples of suitable inhibitors include ethylenically or aromatically unsaturated amides, acetylenic compounds, ethylenically unsaturated isocyanates, olefinic siloxanes, unsaturated hydrocarbon diesters, conjugated ene-ynes, hydroperoxides, nitriles and diaziridines. Specific examples include methylbutynol, dimethylhexynol or ethynylcyclohexanol, trimethyl(3,5-dimethyl-1-hexyn-3-oxy)silane, a maleate, for example bis(2-methoxy-1-methylethyl)maleate or diallyl maleate, a fumarate e.g. diethylfumarate or a fumarate/alcohol mixture wherein the alcohol is, for example, benzyl alcohol or 1-octanol and ethenylcyclohexan-1-ol. If used, an inhibitor can for example be used at 0.1 to 3% by weight of the coating composition.

The invention includes a process for coating a fabric with the coating composition of the invention. The fabric is preferably a woven fabric, particularly a plain weave fabric, but can for example be a knitted or nonwoven fabric. The fabric may be made from synthetic fibres or blends of natural and synthetic fibres, for example polyamide fibres such as nylon-6,6, polyester, polyimide, polyethylene, polypropylene, polyester-cotton, or glass fibres. For use as air bag fabric, the fabric should be sufficiently flexible to be able to be folded into relatively small volumes, but also sufficiently strong to withstand deployment at high speed, e.g. under the influence of an explosive charge. The coating compositions of the invention have good adhesion to plain weave nylon fabrics, which are generally difficult to adhere to, and good penetration into the fabric leading to reduced permeability of the fabric and improved air tightness of air bags made from fabric coated with the composition.

The coating composition of the invention can be applied according to known techniques to the fabric substrate. These include spraying, gravure coating, bar coating, coating by knife-over-roller, coating by knife-over-air, padding, dipping and screen-printing. It is preferred that the composition is applied by a knife-over-air or knife-over-roller coating method. The coating composition can be applied to an air bag fabric which is to be cut into pieces and sewn to assemble an air bag, or to a one piece woven air bag. The coating composition is generally applied at a coat-weight of at least 10 g/m² and preferably at least 15 g/m², and may be applied at up to 100 or 150 g/m². The coating composition of the invention has particular advantage in achieving adequate air tightness of the air bag when applied at low coat weight, that is below 50 g/m², for example in the range 15 to 40 g/m².

Although it is not preferred, it is possible to apply the composition in multiple layers, which together have the coat weights set out above. It is also possible to apply onto the coating composition a further coating, e.g. of a material providing low friction.

The coatings of the invention are capable of curing at ambient temperature over prolonged periods, but the preferred curing conditions for the coating are at elevated temperatures over a period which will vary depending on the actual temperature used, for example 120 to 200° C. for a period of 5 seconds to 5 minutes.

The following examples, where parts and percentages are given in weight unless otherwise stated and where viscosity is measured at 25° C., illustrate the invention. Viscosity measurements were made using a Brookfield Viscometer with spindle 7 at 10 rpm unless otherwise indicated. Vinyl group content was measured by Infrared spectroscopy using standards of the carbon double bond stretch. Molecular weight values were determined using gel permeation chromatography.

### EXAMPLE 1

500 g ‘MS-75D’ fumed silica was charged to a Baker Perkins mixer and 28.9 g water, 52.0 g of a copolymer ViO1 of methylvinylsiloxane and dimethylsiloxane units that has a viscosity of 20 mPa·s and is capped at both molecular terminals with dimethylvinylsiloxy groups, and 90.2 g hexamethyldisilazane were successively added and mixed for 1 hour to form treated filler.

A silicone resin/polyorganosiloxane mix RP1 was prepared by mixing an organopolysiloxane resin of the formula (Me₃SiO_{1/2})ₙ(Me₂ViSiO_{1/2})ₘ(SiO_{4/2})ᵣ, where (n+m)/r=0.71, having number-average molecular weight Mn=4300 and vinyl group content=1.9%, with a dimethylvinylsiloxy-end capped dimethylpolysiloxane of viscosity of 40,000 mPa·s and vinyl group content 0.09%.

52.7% of the silicone resin/polyorganosiloxane mix RP1 was added to 25.9% of a dimethylvinyisiloxy-end capped dimethylpolysiloxane ViP1 of viscosity 2,000 mPa·s and vinyl group content 0.23%. 21.4% of the treated silica filler was added and mixed to form a masterbatch MB43 which could be mixed into both parts of a 2-package silicone rubber coating composition.

A 2-package coating composition was prepared from MB43, RP1, ViO1 and the following ingredients:

### INT:

Platinum catalyst: a 1,3-divinyltetramethyldisiloxane solution of a platinum complex of 1,3divinyltetramethyldisiloxane, having a Pt content of 0.40%

### TiPT Catalyst:

Crosslinker: a copolymer of methylhydrogensiloxane and dimethylsiloxane units of viscosity 5.5 mPa·s capped at both molecular terminals with trimethylsiloxy groups; content of silicon-bonded hydrogen atoms is about 0.73 mass %
Silane S1: 3-methacryloxypropyltrimethoxysilane
Silane S2: 3-glycidoxypropyltrimethoxysilane
Inhibitor: ethynylcyclohexanol.

The formulation of each of the parts of the coating composition is shown in Table 1

TABLE 1

| | Part A - weight % | Part B - weight % |
|---|---|---|
| MB43 | 34.39 | 34.22 |
| RP1 | 63.77 | 46.61 |
| INT | 0.48 | |
| Platinum catalyst | 0.58 | |
| TiPT catalyst | 0.78 | |
| Crosslinker | | 16.40 |
| ViO1 | | 0.36 |
| Silane S1 | | 0.96 |
| Silane S2 | | 1.42 |
| Inhibitor | | 0.03 |

48.6% Part A, 48.6% Part B and 2.8% red pigment were mixed in Hauschild dental mixer for 20 seconds. The resulting coating composition was applied to a 46×46 plain weave 420 denier nylon fabric in a knife over air coater at a target coat weight of 30 g/m². The coater had a forced air heating oven in which the dwell time of the coated fabric was 50 seconds at 193° C. The coat weight was determined by measuring the weight of uncoated samples of material of a specific area and then measuring the weight of coated samples having the same area and determining the weight difference between the two samples.

### EXAMPLES 2 AND 3

Example 1 was repeated using the following amounts of the oligomeric organopolysiloxane ViO1, the amounts of other ingredients being unchanged except that the amount of crosslinker in part 2 was adjusted to maintain the SiH to vinyl molar ratio of 2.69:1:
Example 2—156 g
Example 3—260 g

### EXAMPLE 4

A silica filler masterbatch was prepared by mixing the formulation shown in Table 2 in a Baker Perkins mixer. The materials were successively charged to the mixer and mixed for 1 hour to form the masterbatch.

TABLE 2

| | Parts by Weight |
|---|---|
| ViP1 | 25.89 |
| RP1 | 52.70 |
| MS75 fumed silica | 17.27 |
| Water | 1.00 |
| ViO1 | 0.90 |
| Hexamethyl disilazane | 2.94 |

The masterbatch was used in place of MB43 and mixed with further ingredients as set out in Table 1 to form a 2-part coating composition. The amount of crosslinker in part 2 was adjusted to maintain the SiH to vinyl molar ratio of 2.69:1.

48.6% Part A, 48.6% Part B and 2.8% red pigment were mixed and coated on fabric as described in Example 1.

### EXAMPLES 5 TO 8

Example 4 was repeated using the following amounts of the oligomeric organopolysiloxane ViO1, the amounts of other ingredients being unchanged except that the amount of crosslinker in part 2 was adjusted to maintain the SiH to vinyl molar ratio of 2.69:1:
Example 5—1.80 parts
Example 6—3.60 parts
Example 7—5.40 parts
Example 8—9.00 parts

The adhesion of the coatings of Examples 4 to 8 to the fabric under crease flex was measured using a Scott No.363 type Folding and Abrasion tester sold by Test Machines, Inc. of Ronkokoma, N.Y. and manufactured by Toyo Seiki Seisaku-Sho of Tokyo, Japan. Two 25 mm×120 mm (warp direction) test strips of coated fabric facing each other were placed into the test fixture clamps, which were set for 30 mm grip distance. The reciprocating distance of folding was set at 50 mm. As the sample was moved closer to the place where pressure could be applied, a probe was placed between the coated surfaces so that they ballooned outwards. The applied pressure was adjusted to 1.0kg load. The samples were run at 1000 and 2000 cycles and checked against standards having ratings from 5 (no change) to 3 (unsatisfactory) to 0. The samples were subsequently tested through 500 or 1000 cycle increments, depending on the rate of wear, and checked until the rating fell to 3. Each formulation tested 3 warp cut samples. The rating for each sample after 2000 cycles, and the total number of cycles to reach rating 3, are reported in Table 3.

TABLE 3

| | | Rating | Rating | Rating | | | |
|---|---|---|---|---|---|---|---|
| Ex- | Coat | at | at | at | Cycles | Cycles | Cycles |
| am- | weight | 2000 | 2000 | 2000 | to | to | to |
| ple | g/m² | cycles 1 | cycles 2 | cycles 3 | failure 1 | failure 2 | failure 3 |
| 4 | 30 | 5 | 5 | 5 | 3500 | 4000 | 4000 |
| 5 | 28 | 5 | 5 | 5 | 3000 | 3500 | 4000 |
| 6 | 33 | 5 | 5 | 5 | 7000 | 9000 | 9500 |
| 7 | 33 | 5 | 5 | 5 | 3500 | 4500 | 7500 |
| 8 | 33 | 5 | 5 | 5 | 4500 | 4500 | 5000 |

The coated fabrics of each of Examples 1 to 8, and also fabric coated with a composition prepared as described in Example 4 but with no oligomeric organopolysiloxane containing Si-bonded methyl and vinyl groups and silanol end groups present (comparative example C1) were heat aged for 408 hours at 105° C. and then tested in a crease flex test as described above. The results are shown in Table 4.

TABLE 4

| | | Rating | Rating | Rating | | | |
|---|---|---|---|---|---|---|---|
| Ex- | Coat | at | at | at | Cycles | Cycles | Cycles |
| am- | weight | 2000 | 2000 | 2000 | to | to | to |
| ple | g/m² | cycles 1 | cycles 2 | cycles 3 | failure 1 | failure 2 | failure 3 |
| C1 | 32 | 3 | 5 | 4 | 2000 | 6000 | 3500 |
| 1 | 30 | 5 | 5 | 5 | 6000 | 7000 | 4000 |
| 2 | 31 | 5 | 5 | 5 | 8000 | 7000 | 4000 |
| 3 | 29 | 5 | 5 | 5 | 4000 | 6500 | 3000 |
| 4 | 30 | 5 | 5 | 5 | 7000 | 8000 | 8500 |
| 5 | 28 | 5 | 5 | 5 | 8000 | 9500 | 11000 |
| 6 | 33 | 5 | 5 | 5 | 10000 | 7000 | 7000 |
| 7 | 33 | 5 | 5 | 5 | 11000 | 6500 | 14000 |
| 8 | 33 | 5 | 5 | 5 | 7500 | 8000 | 7000 |

The coated fabrics of each of Examples 1 to 8, and also the fabric coated in comparative example C1, were heat/humidity aged for 1000 hours at 70° C. and 95% relative humidity then tested in a crease flex test as described above. The results are shown in Table 5.

TABLE 5

| | | Rating | Rating | Rating | | | |
|---|---|---|---|---|---|---|---|
| Ex- | Coat | at | at | at | Cycles | Cycles | Cycles |
| am- | weight | 2000 | 2000 | 2000 | to | to | to |
| ple | g/m² | cycles 1 | cycles 2 | cycles 3 | failure 1 | failure 2 | failure 3 |
| C1 | 32 | 5 | 5 | 5 | 5000 | 6000 | 3500 |
| 1 | 30 | 5 | 5 | 5 | 5000 | 5000 | 3000 |
| 2 | 31 | 2 | 1 | 1 | 1500 | 1500 | 500 |
| 3 | 29 | 2 | 5 | 5 | 1500 | 6000 | 6000 |
| 4 | 30 | 5 | 5 | 5 | 3000 | 4000 | 2000 |
| 5 | 28 | 5 | 5 | 5 | 8000 | 8000 | 7000 |
| 6 | 33 | 5 | 5 | 4 | 10000 | 11000 | 3000 |
| 7 | 33 | 5 | 5 | 5 | 9000 | 4000 | 12500 |
| 8 | 33 | 5 | 5 | 5 | 9000 | 10000 | 20000 |

The coated fabrics of each of Examples 4 to 8 were tested for blocking, that is for sticking when the coatings are pressed together face to face. Three pairs of 100 mm×100 mm samples were tested for each Example and were pressed together for 7 days at 105° C. under 9 kg weight. After equilibration to room temperature, the samples were pulled apart by attaching a 50 g weight to the upper edge of one of the paired sheets and lifting the other sheet. All the samples showed instant separation.

The coated fabrics of each of Examples 4 to 8, and also the fabric coated in comparative example C1, were tested for permeability to high pressure air in a test in which samples of the coated fabric were clamped between metal plates having aligned 56 mm diameter circular apertures. The coated face of the fabric was in a chamber which could be pressurized; this chamber was pressurized to 200 kPa air pressure then the air feed was shut. The other face of the fabric was open to atmospheric pressure. The rate at which pressure in the chamber fell was monitored electronically. The pressure after 30 seconds is recorded in Table 6.

TABLE 6

| | | Pressure after 30 seconds in |
|---|---|---|
| Example | Coat weight (g/m²) | (kPa) |
| C1 | 30 | 63 |
| 4 | 30 | 110 |
| 5 | 28 | 141 |
| 6 | 33 | 150 |
| 7 | 33 | 169 |
| 8 | 33 | 146 |

It can be seen from Table 8 that treatment of the filler with the methylvinylsiloxane ditnethylsiloxane copolymer capped with dimethylvinylsiloxy groups gave a substantial reduction in air permeability, or advantage in air pressure retention.

### EXAMPLE 9

A branched polysiloxane (of the type described as (A1) above) was formed by reacting 208.33 grams (1 mole) tetraethyl orthosilicate with 186.40 grams (1 mole) divinyltetramethyldisiloxane in the presence of 0.08 grams (0.0005 mol) of trifluoromethane sulfonic acid followed by addition of 36.93 grams (2.05 moles) of H₂O, 2.73 parts of this branched polysiloxane was reacted with 297.3 parts decamethylcyclopentasiloxane in the presence of 0.005 parts of a trimethyl amine hydroxide phosphazene base catalyst, 0.03 parts potassium silanolate of equivalent weight per potassium of 10,000 and 0.009 parts tris(trimethylsilyl)phosphate. A branched polysiloxane A1a was produced having 0.17% vinyl content, viscosity 21600 mPa·s and weight average molecular weight MW 53,100.

363 g of the branched polysiloxane A1a was charged to a Baker Perkins mixer with 15.0 g water and 81.0 g of a oligorneric organopolysiloxane ViO1. 100 g ‘MS-75D’ fumed silica was added and mixed for 5 minutes. 44.1 g hexamethyldisilazane was added and mixed for 5 minutes. 159.35 g ‘MS-75D’ fumed silica was added and mixed for 35 minutes at room temperature, then for 1 hour at 100° C. to form treated filler.

25.65 g of the branched polysiloxane A1a and 711.9 g of the silicone resin/polyorganosiloxane mix RP1 was added to the treated filler and mixed with cooling to form a masterbatch MB2 which could be mixed into both parts of a 2-package silicone rubber coating composition.

A 2-package coating composition was prepared from the following ingredients, the formulation of each of the parts of the coating composition being shown in Table 7.

TABLE 7

| | Part A - weight % | Part B - weight % |
|---|---|---|
| MB2 | 34.39 | 29.77 |
| RP1 | 63.77 | 46.61 |
| INT | 0.48 | |
| Platinum catalyst | 0.58 | |
| TiPT catalyst | 0.78 | |
| Crosslinker | | 20.85 |
| ViO1 | | 0.36 |
| Silane S1 | | 0.96 |
| Silane S2 | | 1.42 |
| Inhibitor 1 | | 0.03 |

48.6% Part A, 48.6% Part B and 2.8% red pigment were mixed in a Hauschild dental mixer for 20 seconds. The resulting coating composition was applied to a 46×46 plain weave 420 denier nylon fabric in a knife over air coater at various coat weights. The coater had a forced air heating oven in which the dwell time of the coated fabric was 50 seconds at 193° C.

Samples of the coated fabric of Example 9 of different coat weights were tested for permeability to high pressure air by the test described above. The pressure after 30 seconds is recorded in Table 8.

A control sample C2 of a commercially available silicone rubber air bag coating applied to the same fabric at its intended coat weight of 35 g/m² was also tested. A comparison sample C3 of a commercially available coated air bag fabric was also tested and recorded in Table 8.

TABLE 8

| | | Pressure after 30 seconds in |
|---|---|---|
| Example | Coat weight (g/m²) | (kPa) |
| 1 | 20 | 197 |
| 1 | 26 | 198 |
| 1 | 30 | 198 |
| 1 | 35 | 197 |
| C2 | 35 | 198 |
| C3 | | 180 |

It can be seen from Table 2 that the coating of Example 9 showed good pressure retention even at low coat weights. The pressure retention at coat weights of 20, 26 and 30 g/m² was as good as the commercial coating of C2 and better than the commercial coating of C3. Whilst not wishing to be tied to current understandings it is believed this is because the presence of the branched polysiloxane A1a improves both the ability of the composition to coat the textile as well as the shear recovery of the composition.

1. A coating composition for an air bag, the coating comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups, and a silica reinforcing filler, wherein the silica filler is pre-treated with 2% to 60% by weight based on the silica filler of an oligomeric organopolysiloxane containing Si-bonded methyl and vinyl groups and silanol end groups.

2. A coating composition according to claim 1 wherein the oligomeric organopolysiloxane contains 5 to 30% by weight vinyl groups.

3. A coating composition according to claim 1 wherein the oligomeric organopolysiloxane has a weight average molecular weight of 1000 to 10000.

4. A coating composition according to claim 1 wherein the silica filler is present at 2 to 30% by weight of the coating composition.

5. A coating composition according to claim 1 wherein the polyorganosiloxane (A) contains 0.02% to 2% by weight alkenyl groups.

6. A coating composition according to claim 1 wherein the polyorganosiloxane (A) comprises an α,ω-vinyldimethylsiloxy polydimethylsiloxane having a viscosity of from 100 to 90000 mPa·s at 25° C.

7. A coating composition according to claim 1 wherein the molar ratio of Si—H groups in the organosilicon crosslinker to aliphatically unsaturated groups in the organopolysiloxane (A) is from 1.5:1 to 5:1.

8. A process for preparing a coating composition curable to a silicone rubber, the coating composition comprising an organopolysiloxane (A) having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups, and a silica reinforcing filler, wherein the silica filler is treated with 2% to 60% by weight based on the silica filler of an oligomeric organopolysiloxane containing Si-bonded methyl and vinyl groups and silanol end groups, and the filler thus treated is mixed with an organopolysiloxane (A) having aliphatically unsaturated hydrocarbon or hydrocarbonoxy substituents, the organosilicon crosslinker having at least 3 silicon-bonded hydrogen atoms and the catalyst.

9. A process according to claim 8 wherein dry silica filler is mixed with the oligomeric organopolysiloxane.

10. A process according to claim 8 wherein the oligomeric organopolysiloxane and an alkenyl functional polyorganosiloxane (A) containing 0.02% to 2% by weight alkenyl groups are premixed with the silica filler to form a masterbatch containing 10 to 80% by weight silica and the masterbatch is mixed with further organopolysiloxane (A) having aliphatically unsaturated hydrocarbon or hydrocarbonoxy substituents, the organosilicon crosslinker having at least 3 silicon-bonded hydrogen atoms, and the catalyst.

11. A process according to claim 10 wherein the alkenyl functional polyorganosiloxane (A) which is mixed with the oligomeric organopolysiloxane and the silica filler to form the masterbatch comprises an α,ω-vinyldimethylsiloxy polydimethylsiloxane having a viscosity of from 100 to 90000 mPa·s at 25° C.

12-15. (canceled)

16. A process for coating a fabric with a coating composition in accordance with claim 1, the process comprising applying the coating composition to the fabric by spraying, gravure coating, bar coating, coating by knife-over-roller, coating by knife-over-air, padding, dipping, or screen-printing.

17. A process according to claim 16 wherein the fabric is an air bag fabric and the coating composition is applied to the air bag fabric which is to be cut into pieces and sewn to assemble an air bag, or to a one piece woven air bag.

18-20. (canceled)

21. An article made from an air bag fabric coated with a coating composition in accordance with claim 1.

22. An article in accordance with claim 21 selected from emergency chutes for aeroplanes, inflatable rafts, or parachutes.

23. A process according to claim 16 wherein the coating composition is applied at a coat weight in a range of 15 to 40 g/m².
